(19) United States
(12) Patent Application Publication
(10) Pub. No.: US 2013/0019900 A1
(43) Pub. Date: Jan. 24, 2013

(54) CLEANING METHOD AND SYSTEM FOR A VACUUM PUMP

(71) Applicants: Elmar Ehrmann, Bad Gronenbach (DE); Herbert Kirmse, Wolfertschwenden (DE); Johann Wölfle, Obergunzburg (DE)

(72) Inventors: Elmar Ehrmann, Bad Gronenbach (DE); Herbert Kirmse, Wolfertschwenden (DE); Johann Wölfle, Obergunzburg (DE)

(73) Assignee: Multivac Sepp Haggenmuller GmbH & Co. KG, Wolfertschwenden (DE)

(21) Appl. No.: 13/552,478

(22) Filed: Jul. 18, 2012

(30) Foreign Application Priority Data
Jul. 19, 2011 (DE) 102011108092.2

(51) Int. Cl. B08B 9/093

(52) U.S. Cl. 134/18; 134/22.18; 134/94.1; 134/102.1; 134/56 R

(57) ABSTRACT

The invention relates to a method for cleaning a vacuum pump embedded in a technical system. Water is provided for the cleaning, and a rotational speed of the vacuum pump is adjusted to a value in a cleaning rotational speed range. A defined amount of cold water and/or warm water is supplied to the vacuum pump and the vacuum pump is rinsed with the water during a predetermined time period. After letting the water escape from the vacuum pump, the vacuum pump is dried by aeration with gas or a gas mixture. The invention also relates to a cleaning system for cleaning the vacuum pump.

### CROSS-REFERENCE TO RELATED APPLICATION

This Application claims priority to German Application Number 102011108092.2 filed Jul. 19, 2011 to Elmar Ehrmann, Herbert Kirmse and Johann Wolfle entitled “Cleaning Method and System for a Vacuum Pump,” currently pending, the entire disclosure of which is incorporated herein by reference.

### FIELD OF THE INVENTION

The present invention relates to a method and system for cleaning a vacuum pump.

### BACKGROUND

It is known that in the production systems of the food industry, high hygiene standards must be complied with in order to reduce the risk of bacterial contamination of the food to be produced or packaged. For instance, when organic substances, such as foods or pharmaceutical products, are processed, they can come in contact with bacteria or other microorganisms in many ways. Therefore, production systems coming in contact with these products during processing must be cleaned regularly and very thoroughly. To integrate this cleaning in a sensible manner into the production process, a method known as cleaning-in-place (CIP) is known and widespread, which allows performing cleaning, sterilization and disinfection processes within closed production systems.

A washing and cleaning system at packaging machine is known from DE 689 05 158 T2. Therein, the visible components of a packaging machine are cleaned with washing liquids using washing nozzles. This is disadvantageous in that only the visible parts of the packaging machine are cleaned.

A CIP system capable of interior and exterior cleaning of a filling system is known from DE 698 09 668 T2. The CIP system comprises several subsystems for cleaning regions of the filling system from the exterior and the interior.

It is further known, that vacuum pumps are used within packaging machines for evacuating packaging units. Various embodiments of such vacuum pumps are known. For example, EP 1307657 B1 describes a screw vacuum pump. Furthermore, side channel blowers and roots pumps are known from DE 102 07 929 A1. Each of the above-mentioned vacuum pumps runs dry, meaning they work without the use of an operating fluid. If these vacuum pumps are used for the evacuation of food packaging, then it can not be ensured beyond doubt, even by using a filter system, that the vacuum pumps being integrated into the packaging machine or located in its vicinity remain free from contamination. It must moreover be feared, that they are regularly contaminated during operation of the packaging machine, as liquids or product residues can be sucked in.

It is therefore desirable, that a vacuum pump can be cleaned with a CIP system.

### SUMMARY OF THE INVENTION

It is therefore the object of the invention to provide a method and system for CIP for a vacuum pump.

In the method according to one embodiment of the invention for cleaning a vacuum pump embedded in a technical system, for example, a packaging machine, the following steps are provided:

providing water

setting a rotational speed of a vacuum pump to a value in a cleaning rotational speed range;

supplying a defined amount of water;

rinsing the vacuum pump with water during a predetermined time period;

letting the water escape from the vacuum pump; and

drying the vacuum pump by aerating it with gas or a gas mixture.

An advantage of the method according to the invention is that the water is supplied in a defined quantity, since this avoids overfilling the vacuum pump. The water can be supplied as hot water, i.e., water at a temperature of at least 35° C. However, cold water can also be supplied, i.e., water at a temperature below 35° C.

The fact that the rotational speed of the vacuum pump is set to a cleaning rotational speed range value prevents overpressure within the pump, which would arise at too high rotational speeds due to high fluid speeds and an associated increase in hydrodynamic pressure. If the time period for rinsing the vacuum pump is predetermined, then this allows for situational rinsing of the pump in order to save energy and time. In order to perform the subsequent drying more efficiently, it is advantageous to allow the water to escape in advance. Drying the vacuum pump can be performed particularly advantageous by aerating the latter with compressed air, gas or a gas mixture, since they promote evaporation or convection, respectively.

For heavy contamination, a cleaning agent and/or disinfectant can be provided in addition to the water. A rinsing solution of water and optionally an amount of the cleaning agent and optionally an amount of the disinfectant can be mixed in a supply unit which is separated, but integrated into the system.

The cleaning of the vacuum pump may be performed by means of cleaning-in-place (CIP). This enables particularly efficient cleaning of the pump and reduces labor and time input, because the pump does not need to be dismantled prior to being cleaned.

It has shown to be advantageous, if a rotational speed of the vacuum pump is set to a cleaning rotational speed which is lower than the operation rotational speed, because pressure conditions are thus created within the vacuum pump which, for example, avoid cavitational damage to the pump due to high local pressure.

One embodiment of the invention provides for a degree of contamination of the vacuum pump to be determined and stored as information. This information can for example be used as a parameter for adjusting the time period of the rinsing.

It can be particularly advantageous for the rinsing, if a predetermined time period is set for it. This enables situational rinsing of the pump and thus creates high time and energy efficiency. Advantageously, a storable and retrievable cleaning program is stored in a machine controller of the packaging machine.

It has turned out that air, nitrogen, or CO2 are particularly well suited for aerating and drying the vacuum pump. These gases or gas mixtures are, on the one hand, cheaply procured and, on the other hand, simple and safe in storage and handling.

For the life cycle of the vacuum pump, the vacuum pump can be supplied a corrosion agent after drying. In this manner, the corrosion agent removed during the cleaning of the pump can be replenished.

One embodiment of the invention provides that the cleaning is controlled and/or monitored by a control device in the system, which can also be the machine controller. A control device can, depending on the computing capacity, factor in a number of parameters, such as the degree of contamination, in order to enable efficient cleaning.

The mixing of the rinsing solution is performed based on the degree of contamination which is stored in and provided by the control device. In this manner, the amount of cleaning agent and disinfectant is reduced to a required minimum.

It can also be advantageous if the predetermined time period for rinsing is automatically adjusted by the control device. Based on suitable parameters, such as for example the degree of contamination, the time period can be limited to a required minimum.

The cleaning system according to the invention for cleaning a vacuum pump can be characterized by a control device, a supply unit, as well as a fluid reservoir for gaseous fluids (e.g., air), wherein the supply unit comprises at least a fluid reservoir for liquid fluids (e.g., water), a valve connected via a line to the fluid reservoir as well as a feed pump connected via a line to the valve. With the cleaning system thus designed, cleaning a vacuum pump can be accomplished in a particularly thorough manner, saving time and resources. It is furthermore advantageous, that cleaning can be performed without dismantling the vacuum pump.

To fulfill even the most stringent hygiene requirements and enable particularly thorough cleaning and/or disinfection of the vacuum pump, one embodiment of the cleaning system provides for the supply unit additionally comprising one or more fluid reservoirs for a cleaning agent and/or disinfectant, where the supply unit is arranged for mixing the cleaning agent and/or disinfectant.

A check valve may also be provided in a vacuum line of the vacuum pump. The direction of flow of the rinsing solution is therewith determined and any back-flow of the solution being contaminated in the pump is effectively prevented.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic view illustrating the cleaning system for a vacuum pump in accordance with one embodiment of the present invention; and

FIG. 2 is a schematic view illustrating the sealing station of a packaging machine with a cleaning system in accordance with one embodiment of the present invention.

Identical components are designated by identical reference numerals throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

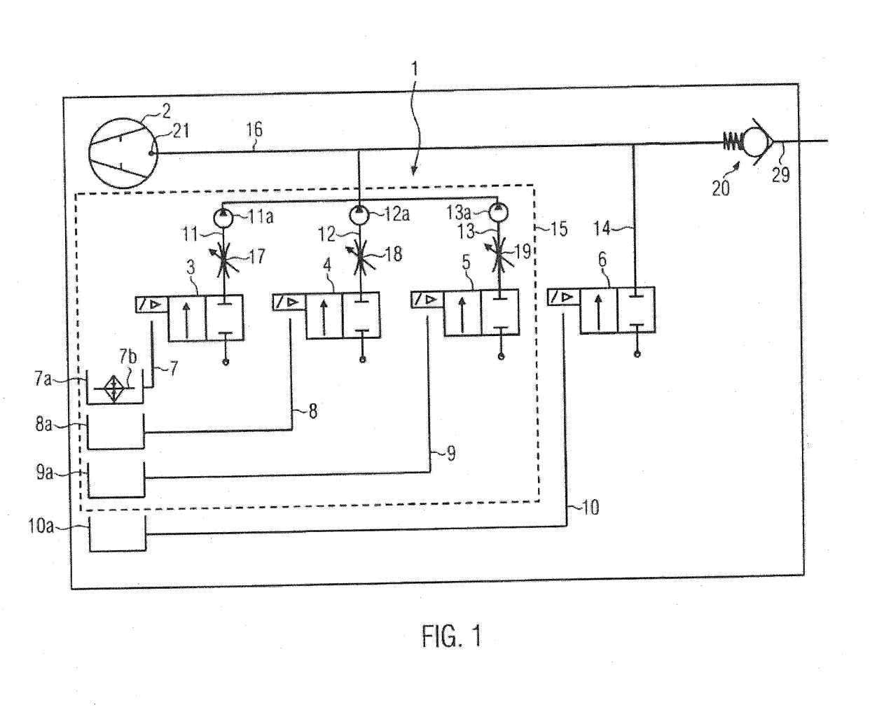

FIG. 1 shows a cleaning system 1 according to the invention for cleaning a vacuum pump 2, being embedded, i.e., integrated, into a technical system 100, for example a packaging machine. The cleaning system 1 may comprise a plurality of valves 3, 4, 5, 6. The valves 3, 4, 5, 6 are in this embodiment each two/two-way valves which are, for example, electrically actuated. The valves 3, 4, 5, 6 are on their feed side each connected via a line 7, 8, 9, 10 with a respective reservoir 7a, 8a, 9a, 10a.

The line 7 is used to supply water to the valve 3, preferably hot water having a water temperature of at least 35° C. or at least 40° C., which is supplied from a reservoir 7a. A heater 7b, which is integrated into the reservoir 7a, heats the water to the respective water temperature. The line 8 being connected to the valve 4 supplies the valve 4 with a cleaning agent from a cleaning agent reservoir 8a preferably containing additives for the prevention of corrosion and/or cavitation.

The line 9 is connected to a reservoir 9a for a disinfectant and supplies it to the valve 5. The valve 6 is supplied with gas or a gas mixture from the reservoir 10a via a connected line 10.

The valves 3, 4, 5 are connected via further lines 11, 12, 13 to a supply unit 15, where the supply unit 15 is by means of a collector line 16 connected to the vacuum pump 2. The valve 6 is connected via a line 14 to the collector line 16. To regulate the line pressure in the lines 11, 12, 13, throttle valves 17, 18, 19 are provided, whose cross section can be adjusted steplessly or in steps. In order to convey the water, the cleaning agent, and the disinfectant, pumps 11a, 12a, 13a are provided in the lines 11, 12, 13. Furthermore, lines 11, 12, 13, 14 are connected by means of the collector line 16 to the vacuum pump 2. The cleaning system 1 may further comprise a check valve 20 to define a flow direction of the rinsing solution or of a gas, supplied via the valve 6, towards the vacuum pump.

The vacuum pump 2 further comprises an integrated escape device 21, i.e., attached in the interior of the vacuum pump 2, which is adapted to let the rinsing solution escape. The escape device 21 can, for example, be a spray device or a vacuum port.

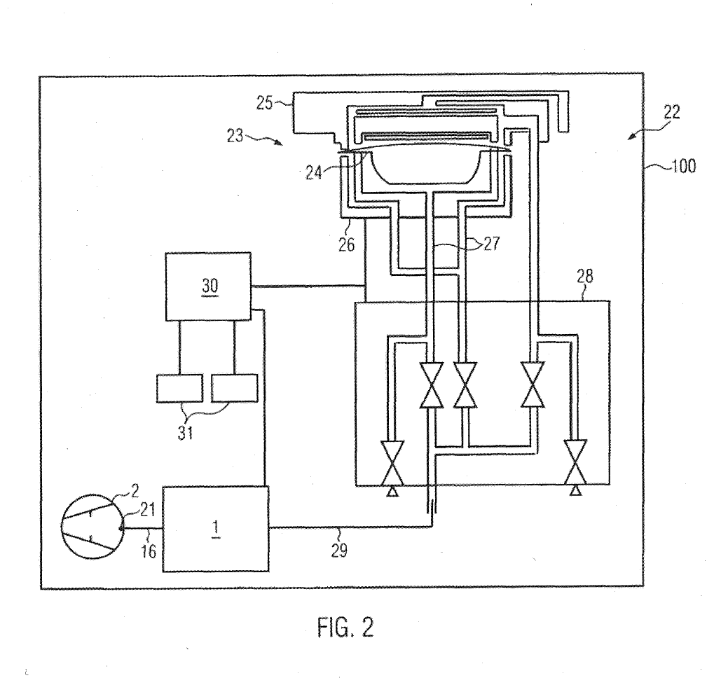

FIG. 2 shows a highly schematic section of a sealing station 22, as it is for example used in the packaging machine 100 which is suitable for foods. The sealing station 22 comprises a tool 23 for evacuating packing units 24. The tool 23 may comprise a sealing tool upper part 25 and a sealing tool lower part 26, where a plurality of suction channels 27 are connected to the sealing tool lower part 26. The suction channels 27 are connected to a vacuum chamber 28, where a vacuum can be created in the vacuum chamber 28 by means of the vacuum pump 2 which is connected thereto by means of a flange connection via the collector line 16 of the cleaning system 1 and a vacuum line 29. For controlling the sealing station 22, as well as the cleaning system 1 integrated into the packaging machine 100, a controller 30 is provided, which preferably simultaneously is used to control the packaging machine 100. The control device 30 can further comprise one or more sensors 31, for example, for measuring a degree of contamination, where the sensors 31 are preferably arranged in the interior of the vacuum pump 2.

The general cleaning method with the cleaning system 1 is described briefly below.

Due to contamination, which occurs through smallest openings or the vacuum line 25 in the vacuum pump 2, regular cleaning of the vacuum pump 2 is necessary. Cleaning of the vacuum pump is preferably performed at intervals, e.g., with every machine start up. Alternatively, the control device 30 can determine a degree of contamination of the vacuum pump 2 by means of the one or more sensors 31. If a defined threshold value is exceeded, cleaning of the vacuum pump 2 is initiated for a next possible suitable point in time, which, for example, can be after completion of a production unit. Depending on parameters, where, for example, an amount of liquid required for cleaning the vacuum pump 2 is considered, the rotational speed of the vacuum pump 2 is adjusted to a value in a cleaning rotational speed range which is lower than the rated or operational rotational speed of the vacuum pump 2.

The cleaning agent stored in the reservoir 8a may be supplied, depending on the degree of contamination, in an amount matched thereto by opening the valve 4 of the supply unit 15. If the control device 30 decides that a disinfectant is likewise to be supplied, then the valve 5 is electronically actuated such that a defined amount of disinfectant flows into the supply unit 15. By actuating the valve 3, the supply unit 15 can be supplied with a certain amount of water. A rinsing solution of a cleaning agent and/or a disinfectant and/or water thus mixed is supplied to the vacuum pump 2.

The vacuum pump 2 continues to run with its above-determined cleaning rotational speed, so that thorough cleaning and possibly disinfection is enabled. The control device 30 determines, based on parameters, for example, the degree of contamination, for which time period rinsing of the vacuum pump 2 is performed. If the predetermined time period for rinsing the vacuum pump 2 has passed, letting the rinsing solution escape from the vacuum pump 2 is initiated.

After letting the rinsing solution escape from the vacuum pump 2, gas or gas mixture can be supplied to the vacuum pump 2 by opening the valve 6. This can be effected either by means of gas pressure acting upon the line 14, or by means of a supply pump. By introducing the gas or gas mixture, the vacuum pump 2 is dried in the interior by convection.

The check valve 20 being disposed in the vacuum line 25 prevents liquids or gases from entering the vacuum chamber 28 during the entire cleaning of the entire vacuum pump 2.

For some construction types of the vacuum pump 2, it can be reasonable, if after drying the vacuum pump 2, the latter is supplied with a corrosion agent for replenishing the removed corrosion agent.

It is further conceivable, that several vacuum pumps 2 are used within or in the vicinity of the packaging machine or the technical system 100, respectively.

Furthermore, the control device 30 can be integrated into a controller of the entire packaging machine 100.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for cleaning a vacuum pump which is embedded in a technical system, said method comprising the steps of:
providing water;
adjusting a rotational speed of said vacuum pump to a value in a cleaning rotational speed range;
supplying a defined amount of said water;
rinsing said vacuum pump with said water during a predetermined time period;
letting said water escape from said vacuum pump; and
drying said vacuum pump by aerating it with gas or a gas mixture.

2. The method of claim 1 further comprising the steps of:
providing at least one of a cleaning agent and a disinfectant; and
mixing a rinsing solution in a supply unit of said system, wherein said rinsing solution comprises an amount of said water and an amount of at least one of said cleaning agent and said disinfectant.

3. The method of claim 1, wherein the rotational speed of said vacuum pump is adjusted to a cleaning rotational speed being lower than an operation rotational speed.

4. The method of claim 1, wherein a degree of contamination of said vacuum pump is determined and stored as information.

5. The method of claim 1, wherein said gas or gas mixture is at least one of ambient air, nitrogen and CO₂.

6. The method of claim 1, wherein said predetermined time period for rinsing said vacuum pump is adjusted.

7. The method of claim 1, wherein said cleaning is controlled and monitored by a control device.

8. The method of claim 6, wherein said predetermined time period for rinsing is adjusted by a control device.

9. A cleaning system for cleaning a vacuum pump, said cleaning system comprising:
a control device;
a supply unit including:
a liquid fluid reservoir for liquid fluids, in particular water;
a valve connected via a first line to said liquid fluid reservoir;
a supply pump connected via a second line to said valve; and
a gaseous fluid reservoir for gaseous fluids,

10. The cleaning system of claim 9, wherein said supply unit further comprises one or more of a cleaning agent fluid reservoir for a cleaning agent and a disinfectant fluid reservoir for a disinfectant and wherein said supply unit is adapted for mixing a rinsing solution using at least one of said cleaning agent and said disinfectant.

11. The cleaning system of claim 9 further comprising a check valve in a vacuum line of said vacuum pump.

12. The cleaning system of claim 9 further comprising one or more sensors, and wherein said control device is adapted for cooperating with said one or more sensors.

13. The cleaning system of claim 9, wherein said cleaning system is incorporated into a packaging machine with a vacuum pump.
